(19) United States
(12) Patent Application Publication
(10) Pub. No.: US 2026/0273705 A1
(43) Pub. Date: Sep. 17, 2026

(54) POWERED RATCHET TOOL WITH MULTI-PIECE CRANKSHAFT ASSEMBLY

(71) Applicant: MILWAUKEE ELECTRIC TOOL CORPORATION, Brookfield, WI (US)

(72) Inventors: Joseph Jurss, Brookfield, WI (US); Benjamin J. Skelton, Milwaukee, WI (US); Joseph J. Drees, Wauwatosa, WI (US); Gabe Berland, Brookfield, WI (US); Mackenzie J. Nick, Theresa, WI (US)

(21) Appl. No.: 19/671,966

(22) Filed: May 8, 2026

Related U.S. Application Data
(63) Continuation-in-part of application No. 18/930,794, filed on Oct. 29, 2024.
(60) Provisional application No. 63/594,326, filed on Oct. 30, 2023.
(60) Provisional application No. 63/802,293, filed on May 8, 2025.

(51) Int. Cl. B25B 21/00; B25B 13/46

(52) U.S. Cl. CPC B25B 21/004; B25B 13/465; B25B 13/467

(57) ABSTRACT

A powered ratchet tool includes a housing with a head portion, a drive assembly including an output rotatable about a first axis, a yoke supported within the head portion and pivotable about a second axis perpendicular to the first axis, an anvil extending from the head portion to engage a socket, a pawl movable between first and second positions to couple the anvil for co-rotation with the yoke about the second axis, and a shaft assembly extending between the output of the drive assembly and the yoke. The shaft assembly is formed as a multi-piece construction including a shaft extending along the first axis, a first coupler fixed to a first end of the shaft, and a second coupler fixed to a second, opposite end of the shaft. The shaft is made of a harder material than at least one of the first coupler or the second coupler.

### CROSS REFERENCE TO RELATED APPLICATIONS

The present application is a continuation-in-part of U.S. patent application Ser. No. 18/930,794, filed Oct. 29, 2024, which claims priority to U.S. Provisional Application No. 63/594,326, filed Oct. 30, 2023. The present application further claims priority to U.S. Provisional Patent Application No. 63/802,293, filed May 8, 2025. The entire contents of all the foregoing applications are incorporated herein by reference

### FIELD

The present invention relates to power tools and, more particularly, to powered ratchet tools.

### BACKGROUND

Powered ratchet tools are used to apply torque to fasteners in confined or otherwise difficult-to-access locations where manual ratchets may be inefficient or impractical.

Such tools are typically powered by an electrical source (e.g., a DC battery or an AC source) or by pressurized air and include a motor and a drive assembly for delivering torque to an output. In many powered ratchet tools, a crankshaft or similar shaft arrangement transmits rotary motion from the drive assembly to a reciprocating yoke in the head portion.

### SUMMARY

The present disclosure provides a powered ratchet tool with a multi-piece crankshaft assembly that addresses limitations of conventional designs. Conventional one-piece crankshafts may be difficult and costly to manufacture due to complex geometry and tight packaging constraints in the head portion, and may limit the ability to tailor material properties of different regions of the shaft for strength, stiffness, durability, balance, and vibration performance. Accordingly, there is a need for improved powered ratchet tool constructions that address one or more of the foregoing issues.

For example, in some aspects, the techniques described herein relate to a powered ratchet tool including: a housing including a head portion; a drive assembly including an output rotatable about a first axis; a yoke supported within the head portion and pivotable about a second axis perpendicular to the first axis; an anvil extending from the head portion and configured to engage a socket; a pawl moveable between a first position, in which the pawl couples the anvil for co-rotation with the yoke in a first direction about the second axis, and a second position, in which the pawl couples the anvil for co-rotation with the yoke in a second direction about the second axis; and a shaft assembly extending between the output of the drive assembly and the yoke, the shaft assembly formed as a multi-piece construction, the shaft assembly including: a shaft extending along the first axis and having a first end and a second end opposite the first end, a first coupler fixed to the first end of the shaft, and a second coupler fixed to the second end of the shaft, wherein at least one coupler selected from a group consisting of: the first coupler and the second coupler, is made of a first material having a first hardness, and wherein the shaft is made of a second material having a second hardness greater than the first hardness.

In some aspects, the techniques described herein relate to a powered ratchet tool including: a housing including a head portion; a drive assembly including an output rotatable about a first axis; a yoke supported within the head portion and pivotable about a second axis perpendicular to the first axis; and a shaft assembly extending between the output of the drive assembly and the yoke, the shaft assembly formed as a multi-piece construction, the shaft assembly including: a shaft extending along the first axis, a first coupler secured to a first end of the shaft and rotationally coupled to the output, a second coupler secured to a second end of the shaft, the second coupler including a pair of wings and an eccentric pin carried by the second coupler and offset from the first axis, such that rotation of the shaft assembly about the first axis causes reciprocation of the yoke about the second axis; wherein the shaft is hollow.

In some aspects, the techniques described herein relate to a powered ratchet tool including: a housing including a head portion; a drive assembly including an output rotatable about a first axis; a yoke supported within the head portion and pivotable about a second axis perpendicular to the first axis; and a shaft assembly extending between the output and the yoke, wherein the shaft assembly includes a shaft, a first coupler secured to a first end of the shaft, and a second coupler secured to a second end of the shaft, wherein the shaft has an outer diameter greater than an outer diameter of each of the first coupler and the second coupler.

In some aspects, the multi-piece construction of the shaft assembly may provide one or more advantages. For example, the multi-piece construction may provide manufacturing flexibility by allowing complex geometries, such as splines and eccentric features, to be produced more cost-effectively using processes such as powdered metal manufacturing. In some aspects, the multi-piece construction may permit different materials to be selected for different components to optimize performance characteristics, such as using ductile materials for the couplers and high-stiffness materials for the shaft. In some aspects, the shaft may have an outer diameter greater than the outer diameters of the couplers to increase torsional stiffness without increasing an overall size of the shaft assembly. In some aspects, the shaft may have a hollow configuration to reduce weight while maintaining torsional stiffness and rotational inertia. In some aspects, the press-fit interface between the couplers and the shaft may provide a higher allowable slip torque while achieving lower stresses at the interface, which may be beneficial in high-torque applications. In some aspects, the combination of reduced mass and increased rotational inertia may improve responsiveness and efficiency of the shaft assembly, for example by enabling more rapid acceleration during motor start-up and increased energy transfer to the yoke in fastener loosening applications.

Other features and aspects of the disclosure will become apparent by consideration of the following detailed description and accompanying drawings.

### BRIEF DESCRIPTION OF THE DRAWINGS

FIG. 1 is a perspective view of a powered ratchet tool embodying aspects of the present disclosure.

FIG. 2 is a cross-sectional view of the powered ratchet tool of FIG. 1, taken along line A-A in FIG. 1.

FIG. 3 is a cross-sectional view of the powered ratchet tool of FIG. 2, taken along line B-B in FIG. 1.

FIG. 4 is a perspective view of a crankshaft assembly of the powered ratchet tool of FIG. 1.

FIG. 5 is a side view of a crankshaft assembly according to another embodiment and which may be incorporated into the powered ratchet tool of FIG. 1.

FIG. 6 is a side view of a crankshaft assembly according to another embodiment and which may be incorporated into the powered ratchet tool of FIG. 1.

FIG. 7 is a side view of a crankshaft assembly according to another embodiment and which may be incorporated into the powered ratchet tool of FIG. 1.

FIG. 8 is a side view of a crankshaft assembly according to another embodiment and which may be incorporated into the powered ratchet tool of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

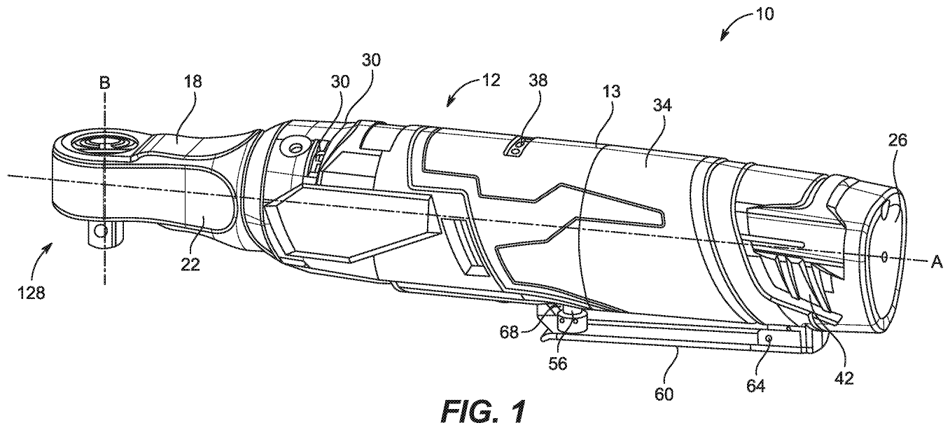

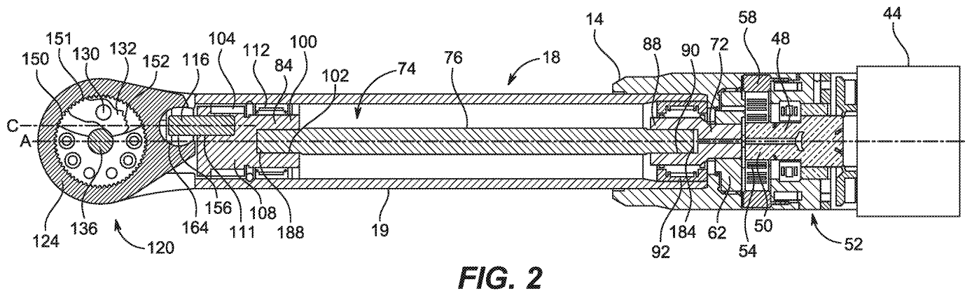

FIG. 1 illustrates a powered ratchet tool 10 including a housing 12 defining a longitudinal center axis A. In the illustrated embodiment, the housing 12 includes a handle portion 13, a drive housing 14 coupled to and supported by the handle portion 13, and a head portion 18 extending from the drive housing 14. In some embodiments, the head portion 18 may include an elongated tubular section 19 to provide the powered ratchet tool 10 with an extended reach (e.g., FIG. 2). In other embodiments, the elongated tubular section 19 may be omitted or shortened to provide the ratchet tool 10 with a more compact form (e.g., FIG. 1). The illustrated handle portion 13 includes a pair of clamshell halves 30. The handle portion 13 also includes a grip 34 that is formed by a resilient material such as rubber or silicone and which is overmolded on the clamshell halves 30. The handle portion 13 is configured to be grasped by a user during use of the ratchet tool 10.

With continued reference to FIG. 1, a battery pack 26 is removably coupled to the housing 12 and, in the illustrated embodiment, is received by the handle portion 13. In particular, the battery pack 26 can be inserted into and removed from a cavity in the handle portion 13 in a direction along the axis A. An indicator 38 supported by the handle portion 13 displays a charge level of the battery pack 26. The battery pack 26 includes a latch 42, which retains the battery pack 26 within the cavity and which can be actuated (e.g., depressed) to release the battery pack 26 from the ratchet tool 10. The illustrated battery pack 26 is a removable and rechargeable 12-volt battery pack and includes three (3) Lithium-ion battery cells. In other constructions, the battery pack 26 may include fewer or more battery cells, different chemistries, and/or different output voltages.

With reference to FIGS. 1 and 2, the ratchet tool 10 includes a motor 44 with a motor shaft 48 rotatable about the axis A when the motor 44 is energized and a switch 56 for selectively connecting the motor 44 to the battery pack 26 (e.g., through circuitry of the switch 56 or through a control system receiving an input from the switch 56). A switch paddle 60 is coupled to the handle portion 13 to be manipulated by a user. When the switch paddle 60 is depressed toward the body of the handle portion 13, the switch 56 is compressed to energize the motor 44. The switch paddle 60 is pivotable about a rod 64. An elastic member 68 engages with the switch paddle 60 to bias the switch paddle 60 away from the switch 56. In some embodiments, the switch 56 is a variable-speed switch configured to control an operating speed of the motor 44. In some embodiments, other types of actuators (e.g., a trigger, push-button, or the like) may be provided for actuating the switch 56.

Referring to FIG. 2, the drive housing 14 at least partially encloses and supports a drive assembly 52 operatively coupled to the motor shaft 48. In some embodiments, the drive housing 14 may be an integral part of the handle portion 13 of the housing 12. In other embodiments, the drive housing 14 may be a separate component, optionally made of a different material (e.g., steel) than the material of the handle portion 13 (e.g., plastic). The illustrated drive assembly 52 is a planetary transmission including a pinion 50 (which may be integral with the motor shaft 48), a plurality of planet gears 54 meshed with the pinion 50, and a ring gear 58 meshed with the planet gears 54 such that rotation of the pinion 50 causes the planet gears 54 to orbit about an inner periphery of the ring gear 58. The drive assembly 52 includes an output 62, which in the illustrated embodiment is a planetary carrier coupled to the planet gears 54 (e.g., by pins). However, other types of drive assemblies may be used, and in some embodiments, the motor shaft 48 itself may define the output 62 of the drive assembly 52. As used herein, the term “integral” means formed together as a single piece.

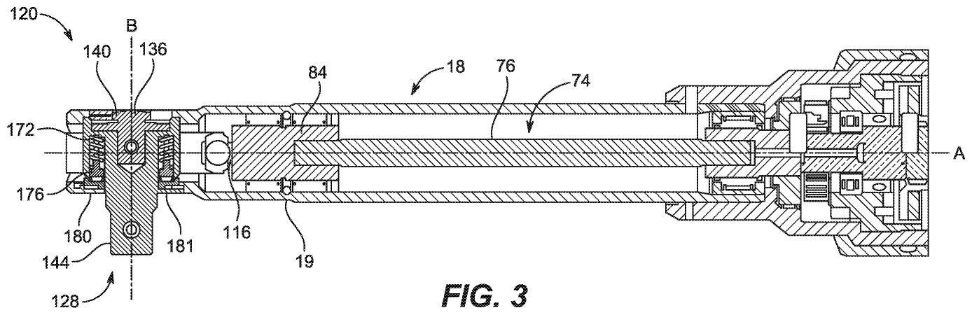

With reference to FIGS. 1-3, the head portion 18 supports an output assembly 120 configured to receive a tool bit, such as a socket, for engagement with a workpiece, such as a fastener. The output assembly 120 includes a yoke 124 having a plurality of yoke teeth 150 (FIG. 2), an anvil 128 having an output member 144 (FIG. 3), such as a square head for engaging sockets, a pawl 132 (FIG. 2), and a forward/reverse switch 136 having a gripping actuator 140 that is accessible through the head portion 18. The anvil 128 is rotatable about a second axis B perpendicular to the first axis A. The gripping actuator 140 can be used to rotate the forward/reverse switch 136 between a first position and a second position.

The yoke 124 is selectively engageable with the pawl 132 via a first set of pawl teeth 151 or a second set of pawl teeth 152. The pawl 132 is moveable, and, more specifically, pivotable, about a pawl pin 130. When the forward/reverse switch 136 is in the first position, the pawl 132 is configured to engage the first set of pawl teeth 151 with the yoke teeth 150 to couple the anvil 128 for co-rotation with the yoke 124 in a first direction but to permit the yoke 124 to rotate relative to the anvil 128 in a second, opposite direction. When the forward/reverse switch 136 is in the second position, the pawl 132 is configured to engage the second set of pawl teeth 152 with the yoke teeth 150 to couple the anvil 128 for co-rotation with the yoke 124 in the second direction but to permit the yoke 124 to rotate relative to the anvil 128 in the first direction.

Referring to FIG. 2-4, the ratchet tool 10 includes a shaft assembly 74 coupled for co-rotation with the output 62 of the drive assembly 52. The illustrated shaft assembly 74 is a multi-piece assembly including a shaft 76 having a first end 184 and a second end 188 opposite the first end 184, a first coupler 72 fixed to the first end 184 of the shaft 76, a second coupler 84 fixed to the second end 188 of the shaft 76, and a pin 116 fixed to the second coupler 84. As described in greater detail below, the shaft assembly 74 transmits a torque from the drive assembly 52 to the yoke 124 to pivotally reciprocate the yoke 124 about the axis B. In some embodiments, the shaft 76 is made of a relatively high-strength material, such as chromoly steel (e.g., 42CrMo steel) and is machined to a desired shape and size for the powered ratchet tool 10. The multi-piece construction advantageously allows the couplers 72, 84 to be manufactured using powdered metal processes that are more cost-effective for complex geometries, while the shaft 76 can be made from high-strength materials optimized for torque transmission.

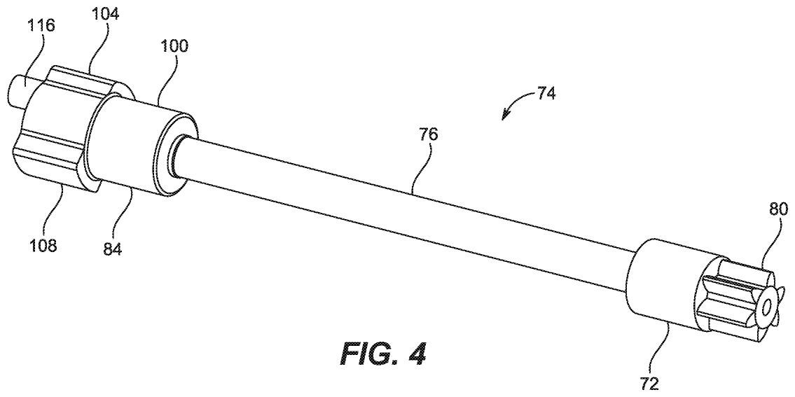

Best illustrated in FIG. 4, the illustrated first coupler 72 includes an interlocking feature, such as a spline 80 as illustrated or another geometric feature, such as a key, square or hex geometry, or the like, that cooperates with a corresponding interlocking feature (e.g., female spline) formed in the output 62 of the drive assembly 52 (FIG. 2). The first coupler 72 further includes a cylindrical portion 88 extending from the spline 80 and having a recess 90 opposite the spline 80. Because the first coupler 72 is formed separately from the shaft 76, the first coupler 72 may be made of a different material, a different manufacturing process, and/or have different material properties than the shaft 76. For example, the first coupler 72 in the illustrated embodiment is made of powdered metal via a suitable powdered metal manufacturing process, such as compaction and sintering. This may allow the relatively complex geometric features of the first coupler 72 (e.g., including the spline 80) to be produced in a less costly manner than machining or forging. In other embodiments, the first coupler 72 may be manufactured through traditional machining, casting, or some combination of machining, casting, and powder metallurgy.

Referring to FIG. 2, the recess 90 receives the first end 184 of the shaft 76 in a press-fit. However, the first coupler 72 may be coupled to the shaft 76 in other ways, such as welding, brazing, mechanical fasteners, etc. In this way, the first coupler 72 couples the shaft 76 to the output 62 for co-rotation therewith about the axis A. The cylindrical portion 88 of the first coupler 72 is supported for rotation about the axis A by a bearing 92.

Referring to FIGS. 2 and 4, the illustrated second coupler 84 includes a cylindrical portion 100 with a recess 102, a first wing 104 and a second wing 108 extending from the cylindrical portion 100, and an eccentric recess 111 that defines a third axis C parallel to the first axis A. The pin 116 is press-fit (or otherwise fixed) within the eccentric recess 111 such that the pin 116 extends along the third axis C. A drive bushing 156 is coupled to the pin 116 and received within a drive recess 164 formed in the yoke 124. The recess 102 receives the second end 188 of the shaft 76 in a press-fit. However, the second coupler 84 may be coupled to the shaft 76 in other ways, such as welding, brazing, mechanical fasteners, etc. The cylindrical portion 100 of the second coupler 84 is supported for rotation about the axis A by a bearing 112. Due to the eccentric position of the pin 116 (i.e., offset from the first axis A), rotation of the shaft 76 about the first axis A causes the yoke 124 to pivotally reciprocate about the second axis B. The wing 104 provides additional material thickness for the eccentric recess 111 to accommodate the pin 116, and the wing 108 is sized to balance the second coupler 84 and minimize vibrations. The wings 104, 108 may be asymmetrically sized. Specifically, the size and shape of the wings 104, 108 are selected so that the center of mass of the second coupler 84 is intersected by the first axis A to minimize vibration during rotation of the shaft assembly 74. Like the first coupler 72, the second coupler 84 may be made of powdered metal by a suitable powdered metal process. In other embodiments, the second coupler 84 may be manufactured through traditional machining, casting, or some combination of machining, casting, and powder metallurgy.

In operation, the shaft assembly 74 rotates about the first axis A and transmits torque from the motor 44 (via the drive assembly 52) to the yoke 124 to reciprocate the yoke 124 about the second axis B. Depending on the position of the pawl 132 and the forward/reverse switch 136, the anvil 128 will be driven in either a first rotational direction or a second rotational direction. The multi-piece construction of the shaft assembly 74 advantageously permits components of the shaft assembly 74 to be made of different materials and/or by different manufacturing processes. For example, instead of forging the shaft assembly 74 as a single piece of steel, which may be difficult and costly due to the complex geometry of the shaft assembly 74, the first and second couplers 72, 84 may be made from powdered metal, or in other ways that provide greater manufacturing efficiency for complex shapes. The remaining shaft 76 and pin 116 can then have simple cylindrical shapes formed in a variety of ways using solid steel. The couplers 72, 84 may have different hardnesses than the shaft 76 and pin 116 in some embodiments. For example, one or both couplers 72, 84 may have a lower hardness than the shaft 76 and the pin 116.

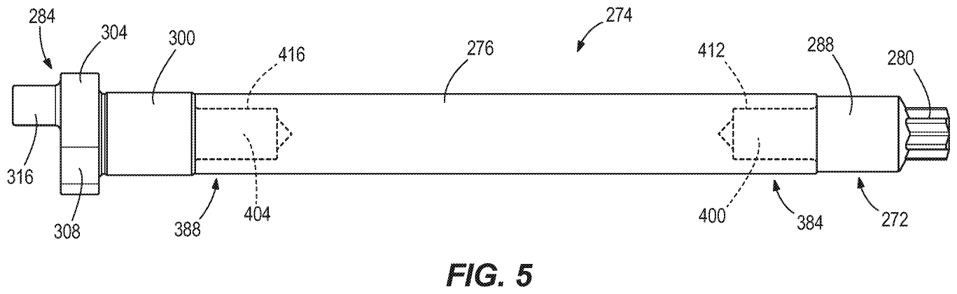

FIG. 5 illustrates another shaft assembly 274 that may be incorporated into the ratchet tool 10 of FIGS. 1-3. The shaft assembly 274 is similar to the shaft assembly 74 of FIGS. 1-4; therefore, like structure will be identified by like reference numbers plus “200.” The following description focuses primarily on differences between the shaft assembly 274 and the shaft assembly 74, and it should be understood that features of the shaft assembly 74 may be incorporated into the shaft assembly 274, and vice versa.

The illustrated shaft assembly 274 is a multi-piece assembly including a shaft 276 having a first end 384 and a second end 388 opposite the first end 384, a first coupler 272 fixed to the first end 384 of the shaft 276, a second coupler 284 fixed to the second end 388 of the shaft 276, and a pin 316 fixed to the second coupler 284. As illustrated, the first coupler 272 has an interlocking feature, such as a spline 280. In other embodiments, the interlocking feature of the first coupler 272 may be another geometric feature, such as a key, square, hex geometry, or the like. Also, the first coupler 272 has a cylindrical portion 288 extending from the spline 280 and a first protrusion 400 extending from the cylindrical portion 288 opposite the spline 280.

The second coupler 284 has a cylindrical portion 300, a first wing 304, and a second wing 308, in which the wings 304, 308 extend from the cylindrical portion 300. The pin 316 is an eccentric pin that is integral with the second coupler 284 and extends from the cylindrical portion 300. Also, the second coupler 284 has a second protrusion 404 extending from the cylindrical portion 300 opposite the pin 316. The first protrusion 400 of the first coupler 272 is received within a first bore 412 that is defined within the first end 384 of the shaft 276. The second protrusion 404 of the second coupler 284 is received within a second bore 416 that is defined within the second end 388 of the shaft 276. As such, the first protrusion 400 of the first coupler 272 is press-fit into the first bore 412 and the second protrusion 404 of the second coupler 284 is press-fit into the second bore 416. Pressing the coupler protrusions 400, 404 into the bores 412, 416 of the shaft 276, rather than pressing the shaft into the couplers, allows for a higher allowable slip torque of the shaft assembly 274 while achieving lower stresses at the press-fit interface locations between the shaft 276 and the couplers 272, 284. As such, the shaft assembly 274 inhibits any slip or rotation of the couplers 272, 284 about the shaft 276 relative to each other in ratchet tools having a high torque drive assembly and a high inertia motor.

The multi-piece construction of the shaft assembly 274 enables strategic material selection to optimize different performance characteristics in different regions of the assembly. Because the first coupler 272 and the second coupler 284 are formed separately from the shaft 276, the couplers 272, 284 may be made of a different material, a different manufacturing process, and/or different material properties than the shaft 276. For example, the illustrated couplers 272, 284 are each made of a relatively ductile material, while the shaft 276 is made of a material with a high stiffness to increase the torsional stiffness of the shaft 276 without sacrificing toughness at the ends 384, 388. For embodiments in which the shaft assembly 274 serves as an elongated crankshaft for an extended length ratchet tool, the shaft 276 may be susceptible to a twisting action. Increasing the torsional stiffness of the shaft 276 due to the particular material of the shaft 276 ultimately improves resistance to the twisting action.

In some embodiments, the couplers 272, 284 may be made of a ductile material, such as low-carbon steel. The shaft 276 may be made of high-carbon steel, steel with surface hardening treatment, or other suitable material. In other embodiments, the shaft 276 may be made of any steel alloy with an elastic modulus higher than the steel of which the couplers 272, 284 are made. For example, the shaft 276 may be made of titanium alloys, nickel-based alloys, 300M steel alloy, maraging steel, tungsten, or silicon carbide. These materials may provide one or more beneficial properties for the shaft application, such as a high elastic modulus, a high strength-to-weight ratio, fatigue resistance, increased torsional stiffness, corrosion resistance, and durability under cyclic loading conditions. The selection of a particular material for the shaft 276 may depend on the specific performance requirements of the powered ratchet tool, including considerations of weight, stiffness, strength, and operating environment. In additional embodiments, increasing the torsional stiffness of the shaft 276 may be dependent upon an outer diameter of the shaft 276 and the elastic modulus. In further embodiments, the shaft 276 may undergo a heat treatment process such as case hardening (e.g., a carburizing treatment or a nitriding treatment). Such heat treatment processes may increase surface hardness, wear resistance, and fatigue strength of the shaft 276, which may extend the service life of the shaft assembly 274 under repeated cyclic loading.

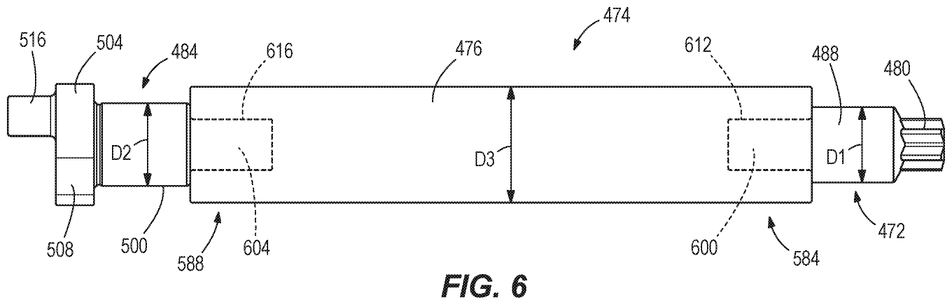

FIG. 6 illustrates another shaft assembly 474 that may be incorporated into the ratchet tool 10 of FIGS. 1-3. The shaft assembly 474 is similar to the shaft assembly 274 of FIG. 5; therefore, like structure will be identified by like reference numbers plus “200.” The following description focuses primarily on differences between the shaft assembly 474 and the shaft assembly 274, and it should be understood that features of the shaft assembly 74 and the shaft assembly 274 may be incorporated into the shaft assembly 474, and vice versa.

The illustrated shaft assembly 474 is a multi-piece assembly including a shaft 476 having a first end 584 and a second end 588 opposite the first end 584, a first coupler 472 fixed to the first end 584 of the shaft 476, a second coupler 484 fixed to the second end 588 of the shaft 476, and a pin 516 fixed to the second coupler 484. The first coupler 472 has a spline 480, a cylindrical portion 488 extending from the spline 480, and a first protrusion 600 extending from the cylindrical portion 488 opposite the spline 480. The second coupler 484 has a cylindrical portion 500, a first wing 504, a second wing 508, and a second protrusion 604 extending from the cylindrical portion 500 opposite the pin 516. As such, the first protrusion 600 of the first coupler 472 is press-fit into a first bore 612 of the shaft 476 and the second protrusion 604 of the second coupler 484 is press-fit into a second bore 616 of the shaft 476.

The cylindrical portion 488 of the first coupler 472 has a first coupler outer diameter D1. The cylindrical portion 500 of the second coupler 484 has a second coupler outer diameter D2. In the illustrated embodiment, the first coupler outer diameter D1 is substantially equal to the second coupler outer diameter D2. The shaft 476 has a shaft outer diameter D3 that is greater than the first coupler outer diameter D1 and the second coupler outer diameter D2 to thereby increase inertia or output power of the shaft assembly 474 while increasing torsional stiffness of the shaft 476 without sacrificing toughness. In addition, the shaft outer diameter D3 is less than a first bearing outer diameter of a first bearing (not shown) configured to rotatably support the cylindrical portion 488 of the first coupler 472 and a second bearing outer diameter of a second bearing (not shown) configured to rotatably support the cylindrical portion 500 of the second coupler 484. As such, the inertia of the shaft assembly 474 and the torsional stiffness of the shaft 476 is further increased without increasing a size of the shaft assembly 474. This configuration may provide multiple advantages: the increased shaft outer diameter D3 may enhance both rotational inertia (for improved energy transfer to the yoke) and torsional stiffness (for reduced twisting under load), while maintaining coupler outer diameters D1, D2 that fit within the existing bearing envelope, thereby achieving performance improvements without requiring larger tool housing dimensions.

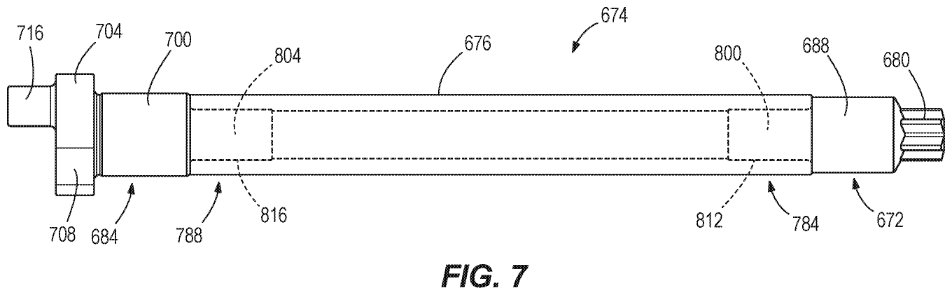

FIG. 7 illustrates another shaft assembly 674 that may be incorporated into the ratchet tool 10 of FIGS. 1-3. The shaft assembly 674 is similar to the shaft assembly 274 of FIG. 5; therefore, like structure will be identified by like reference numbers plus “400.” The following description focuses primarily on differences between the shaft assembly 674 and the shaft assembly 274, and it should be understood that features of the shaft assembly 74, the shaft assembly 274, and the shaft assembly 474 may be incorporated into the shaft assembly 674, and vice versa.

The illustrated shaft assembly 674 is a multi-piece assembly including a shaft 676 having a first end 784 and a second end 788 opposite the first end 784, a first coupler 672 fixed to the first end 784 of the shaft 676, a second coupler 684 fixed to the second end 788 of the shaft 676, and a pin 716 fixed to the second coupler 684. The first coupler 672 has a spline 680, a cylindrical portion 688 extending from the spline 680, and a first protrusion 800 extending from the cylindrical portion 688 opposite the spline 680. The second coupler 684 has a cylindrical portion 700, a first wing 704, a second wing 708, and a second protrusion 804 extending from the cylindrical portion 700 opposite the pin 716. The shaft 676 has a hollow configuration to thereby decrease the weight of the shaft 676, and in turn, the overall weight of the shaft assembly 674.

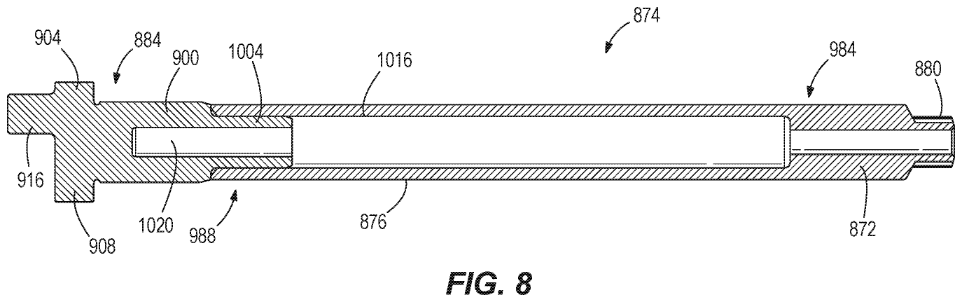

FIG. 8 illustrates another shaft assembly 874 that may be incorporated into the ratchet tool 10 of FIGS. 1-3. The shaft assembly 874 is similar to the shaft assembly 274 of FIG. 5; therefore, like structure will be identified by like reference numbers plus “600.” The following description focuses primarily on differences between the shaft assembly 874 and the shaft assembly 274, and it should be understood that features of the shaft assembly 74, the shaft assembly 274, the shaft assembly 474, and the shaft assembly 674 may be incorporated into the shaft assembly 874, and vice versa.

The illustrated shaft assembly 874 is a multi-piece assembly including a shaft 876 having a first end 984 and a second end 988 opposite the first end 984, a first coupler 872 integral with the shaft 876 at the first end 984 of the shaft 876, a second coupler 884 fixed to the second end 988 of the shaft 876, and a pin 916 fixed to the second coupler 884. The first coupler 872 has an interlocking feature, such as a spline 880. The second coupler 884 has a cylindrical portion 900, a first wing 904, a second wing 908, and a second protrusion 1004 extending from the cylindrical portion 900 opposite the pin 916. The shaft assembly 874 has a hollow configuration such that the shaft 876 has a through bore 1016 and the second coupler 884 has a blind bore 1020 defined therein. The second protrusion 1004 of the second coupler 884 is press-fit into the through bore 1016 of the shaft 876.

The hollow configuration of the shaft 876 and the shaft 676 reduces the overall mass of the shaft 876, 676 (and thus the corresponding shaft assembly 874, 674) while permitting the shaft 876, 676 to maintain a relatively large outer diameter to increase torsional stiffness and rotational inertia. This combination of reduced mass and increased inertia can improve the responsiveness and efficiency of the shaft assembly, for example by enabling the shaft assembly to accelerate more rapidly during start-up of the motor 44. In some aspects, the hollow configuration may provide a unique combination of benefits that are particularly advantageous for loosening applications. By reducing the overall mass of the shaft assembly, the hollow design may enable more rapid acceleration during motor start-up. This increased acceleration, combined with the maintained high rotational inertia from the large outer diameter, may result in greater energy transfer to the yoke 124 during each reciprocation cycle. In fastener loosening applications, this may translate to higher impact forces and improved loosening torque for a given energy input from the motor 44, which may make the tool more effective at breaking free seized or over-torqued fasteners. In some aspects, the hollow geometry may enable weight reduction while maintaining increased rotational inertia due to the larger outer diameter, and this balance of lower mass and higher inertia may be beneficial for both the performance and efficiency of the powered ratchet tool 10.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A powered ratchet tool comprising:
a housing including a head portion;
a drive assembly including an output rotatable about a first axis;
a yoke supported within the head portion and pivotable about a second axis perpendicular to the first axis;
an anvil extending from the head portion and configured to engage a socket;
a pawl movable between a first position, in which the pawl couples the anvil for co-rotation with the yoke in a first direction about the second axis, and a second position, in which the pawl couples the anvil for co-rotation with the yoke in a second direction about the second axis; and
a shaft assembly extending between the output of the drive assembly and the yoke, the shaft assembly formed as a multi-piece construction, the shaft assembly including:
a shaft extending along the first axis and having a first end and a second end opposite the first end,
a first coupler fixed to the first end of the shaft, and
a second coupler fixed to the second end of the shaft,
wherein at least one coupler selected from a group consisting of: the first coupler and the second coupler, is made of a first material having a first hardness, and
wherein the shaft is made of a second material having a second hardness greater than the first hardness.

2. The powered ratchet tool of claim 1, wherein the first coupler has a first outer diameter and the second coupler has a second outer diameter, and wherein the shaft has a third outer diameter greater than the first outer diameter and the second outer diameter.

3. The powered ratchet tool of claim 2, wherein the third outer diameter of the shaft is less than a first bearing outer diameter of a first bearing configured to rotatably support the first coupler and a second bearing outer diameter of a second bearing configured to rotatably support the second coupler.

4. The powered ratchet tool of claim 1, wherein the shaft is hollow.

5. The powered ratchet tool of claim 2, wherein the shaft has an outer diameter selected to increase torsional stiffness without increasing an overall size of the shaft assembly.

6. The powered ratchet tool of claim 1, wherein the shaft assembly further includes an eccentric pin coupled to the second coupler and configured to drive reciprocation of the yoke.

7. The powered ratchet tool of claim 6, wherein the eccentric pin is integral with the second coupler.

8. The powered ratchet tool of claim 1, wherein the first coupler includes a first protrusion press-fit into a first bore defined at the first end of the shaft, and wherein the second coupler includes a second protrusion press-fit into a second bore defined at the second end of the shaft.

9. A powered ratchet tool comprising:
a housing including a head portion;
a drive assembly including an output rotatable about a first axis;
a yoke supported within the head portion and pivotable about a second axis perpendicular to the first axis; and
a shaft assembly extending between the output of the drive assembly and the yoke, the shaft assembly formed as a multi-piece construction, the shaft assembly including:
a shaft extending along the first axis,
a first coupler secured to a first end of the shaft and rotationally coupled to the output,
a second coupler secured to a second end of the shaft, the second coupler including a pair of wings, and
an eccentric pin carried by the second coupler and offset from the first axis, such that rotation of the shaft assembly about the first axis causes reciprocation of the yoke about the second axis,
wherein the shaft is hollow.

10. The powered ratchet tool of claim 9, wherein the shaft has a through-bore extending along the first axis.

11. The powered ratchet tool of claim 10, wherein the second coupler includes a blind bore extending along the first axis.

12. The powered ratchet tool of claim 9, wherein the first coupler is integral with the shaft.

13. The powered ratchet tool of claim 9, wherein the second coupler includes a cylindrical portion and first and second wings extending radially from the cylindrical portion.

14. The powered ratchet tool of claim 9, wherein the eccentric pin is received within a recess formed in one of the wings.

15. The powered ratchet tool of claim 9, wherein the wings are asymmetrically sized such that a center of mass of the second coupler lies on the first axis.

16. A powered ratchet tool comprising:
a housing including a head portion;
a drive assembly including an output rotatable about a first axis;
a yoke supported within the head portion and pivotable about a second axis perpendicular to the first axis; and
a shaft assembly extending between the output and the yoke,
wherein the shaft assembly includes a shaft, a first coupler secured to a first end of the shaft, and a second coupler secured to a second end of the shaft, and
wherein the shaft has an outer diameter greater than an outer diameter of each of the first coupler and the second coupler.

17. The powered ratchet tool of claim 16, wherein the shaft has an outer diameter selected to increase torsional stiffness without increasing an overall size of the shaft assembly.

18. The powered ratchet tool of claim 16, wherein the shaft has an outer diameter smaller than an outer diameter of bearings supporting rotation of the first coupler and the second coupler.

19. The powered ratchet tool of claim 16, wherein the shaft is hollow.

20. The powered ratchet tool of claim 16, wherein the second coupler includes an eccentric pin offset from the first axis and configured to impart reciprocating motion to the yoke.
